(19) United States
(12) Patent Application Publication
(10) Pub. No.: US 2013/0196231 A1
(43) Pub. Date: Aug. 1, 2013

(54) BATTERY FOR AN IMPLANTABLE MEDICAL DEVICE

(71) Applicant: Christian S. Nielsen, River Falls, WI (US)

(72) Inventor: Christian S. Nielsen, River Falls, WI (US)

(73) Assignee: MEDTRONIC, INC., Minneapolis, MN (US)

(21) Appl. No.: 13/359,985

(22) Filed: Jan. 27, 2012

(51) Int. Cl. H01M 4/54; H01R 43/16; H01M 4/04; H01M 4/64; H01M 4/70

(52) U.S. Cl. 429/219; 429/233; 429/245; 29/874

(57) ABSTRACT

A battery may include a first electrode and a second electrode. In some examples, the first electrode may include a metal substrate including a major surface, where a plurality of tunnels extend into the major surface, and an electrode composition is deposited onto the major surface of the metal substrate, where a portion of the electrode composition is positioned within the plurality of tunnels. The battery may be positioned within a housing of an implantable medical device (IMD).

### TECHNICAL FIELD

The disclosure relates to batteries and, more particularly, to batteries of medical devices.

### BACKGROUND

Medical devices such as implantable medical devices (IMDs) include a variety of devices that deliver therapy (such as electrical simulation or drug delivery) to a patient, monitor a physiological parameter of a patient, or both. IMDs typically include a number of functional components encased in a housing. The housing is implanted in a body of the patient. For example, the housing may be implanted in a pocket created in a torso of a patient. The housing may include various internal components such as batteries and capacitors to deliver energy for therapy delivered to a patient and/or monitoring a physiological parameter of a patient.

### SUMMARY

In general, the disclosure is directed to a battery for an implantable medical device (IMD) and techniques for manufacturing the battery. The battery may be positioned within a housing of the IMD to provide, e.g., energy for therapy delivered to a patient and/or monitoring a physiological parameter of a patient.

In some examples, the battery may comprise a first electrode comprising a metal substrate including a major surface, where a plurality of tunnels extend into the major surface within a range of from approximately 5 percent to approximately 80 percent of a thickness of the metal substrate, and an electrode composition deposited onto the major surface of the metal substrate, wherein a portion of the electrode composition is positioned within the plurality of tunnels. In some examples, the battery may further include a second electrode and a separator, where the separator is positioned between the first electrode and the second electrode.

In one aspect, the disclosure is directed to an implantable medical device comprising a housing and a battery positioned within the housing. In some examples, the battery may comprise a first electrode comprising a first electrode having a major surface, where a plurality of tunnels extend into the major surface within a range of from 5 percent to 80 percent of a thickness of the metal substrate. According to this aspect of the disclosure, the first electrode may further include an electrode composition deposited onto the major surface of the metal substrate, wherein a portion of the electrode composition is positioned within the plurality of tunnels. According to this aspect of the disclosure, the battery may further include a second electrode.

In a further aspect, the disclosure is directed to a method of forming an electrode structure. In some examples, the method includes etching a metallic foil to form a plurality of tunnels extending into a major surface of the metallic foil, wherein the plurality of tunnels extend into the major surface within a range of from approximately 5 percent to approximately 80 percent of a thickness of the metallic foil. According to this aspect of the disclosure, the method may further include depositing an electrode composition onto the major surface of the metallic foil, wherein a portion of the electrode composition is positioned within the plurality of tunnels.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram that illustrates an example therapy system that may be used to deliver therapy to a patient.

FIG. 2 is a cross-sectional diagram illustrating an example of a battery that may be used in an implantable medical device.

FIG. 3 is a cross-sectional diagram illustrating an example of a metal substrate of an electrode.

FIG. 4A is a conceptual diagram illustrating an example electrode 90 including an electrode composition 102 deposited onto metal substrate 92 via a solvent.

FIG. 4B is a conceptual diagram illustrating an example electrode 90 including an electrode composition 102 deposited onto metal substrate 92.

FIG. 5 is a flow diagram illustrating an example technique of forming an electrode structure.

FIG. 6 is a scanning electron microscope (SEM) image illustrating an example etched aluminum foil including a plurality of tunnels.

FIG. 7 is a SEM image illustrating a surface view of the etched aluminum foil in FIG. 6.

FIG. 8 is a SEM image illustrating an electrode structure including an example dried electrode composition deposited onto the etched aluminum foil of FIG. 6.

FIG. 9 is a SEM image of the electrode structure in FIG. 8.

FIG. 10 is a SEM image of the electrode structure of FIG. 8 after the electrode structure has been compressed.

### DETAILED DESCRIPTION

In general, the disclosure is directed to battery for a medical device, such as, e.g., an implantable medical device (IMD). IMDs include a variety of devices that deliver therapy (such as electrical simulation therapy or drug delivery therapy) to a patient, monitor a physiological parameter of a patient, or both. IMDs may include a number of functional components encased in a housing. For example, a battery may be positioned within a housing of the IMD to supply energy for therapy delivered to a patient and/or monitoring one or more physiological parameters of a patient. The housing is implanted in a body of the patient. For example, the housing may be implanted in a pocket created in a torso of a patient.

Aspects of this disclosure describe a battery including a first and a second electrode, where at least one of electrodes includes a metal substrate that is etched such that a plurality of tunnels extend into a major surface of the metal substrate. Aspects of this disclosure also describe methods for producing an electrode structure having a plurality of tunnels.

As design specifications change for IMDs (e.g., reduced volume, shape flexibility, longevity etc.), battery design may follow suit. For example, as size requirements for an implantable cardiac device (ICD) decrease, batteries employed in the ICDs may be required to meet the ICD size requirement while still achieving ICD longevity and charge time requirements. Electrodes employed in the ICDs may include a metal substrate and an electrode composition including an active material.

In some examples, a binder material may be used in the electrode composition to increase the cohesion between the particles of the electrode material. Increasing the cohesion between the particles may therefore increases the adhesion or anchoring between the active materials of the electrode composition and the metal substrate. In some examples, as the electrode size is reduced, an amount of a binder material in the electrode composition may be increased to increase the adhesion between the active materials to the metal substrate. However, increasing the amount of the binder material may adversely affect electrical properties (e.g., energy density, resistance, etc.).

In one aspect, this disclosure is directed to a battery having thinner electrodes that may yield similar power performance characteristics as thicker electrodes but have a reduced finished volume and energy capacity. For example, according to one aspect of the disclosure, an electrode of a battery may include an etched metal substrate. The etched metal substrate may include, for example, a plurality of tunnels extending into a major surface of the metal substrate. The plurality of tunnels may extend into the major surface within a range of from approximately 5 percent (%) to approximately 80% of a thickness of the metal substrate. According to this aspect of the disclosure, an electrode composition may be deposited onto the major surface of the metal substrate, where a portion of the electrode composition is positioned within the plurality of tunnels.

Utilizing the etched metal substrate may promote mechanical adhesion of the electrode composition to the metal substrate. That is, instead of increasing the amount of the binder material to promote other types of adhesion such as chemical, van der Vaal, or diffusive adhesion, the etched metal substrate promotes mechanical adhesion by enabling a portion of the electrode composition to be positioned within the plurality of tunnels. For example, the plurality of tunnels are formed to enable a portion of the electrode composition to be wicked into the plurality of tunnels via a solvent. Promoting the mechanical adhesion of the electrode composition to the metal substrate may enable greater design flexibility for the battery. Additionally, increasing the mechanical adhesion between the electrode composition and the metal substrate may reduce the amount of binder material in the electrode composition. As noted above, increasing the amounts of binder material in the electrode composition may undesirably affect electrical properties of the electrode composition.

According to another aspect of this disclosure, the plurality of tunnels do not extend through the entire thickness of the metal substrate. For example, the plurality of tunnels may extend into a major surface of the metal substrate within a range from approximately 5% to approximately 80% of a thickness of the metal substrate. In other words, the plurality of tunnels do not extend through the entire thickness of the metal substrate. Therefore, a portion of the metal substrate may not be etched and does not include the plurality of tunnels. As discussed herein, the depth of the plurality of tunnels may be limited (e.g., do not extend through the entire thickness of the metal substrate) such that the metal substrate can act as a suitable current collector. Additionally, the depth of the plurality of tunnels may be limited such that the integrity metal substrate is maintained (e.g., maintains intact) to act as a suitable support for the electrode composition.

Etching the metal substrate such that a plurality of tunnels extend through the entire thickness of the metal substrate may decrease the ability of the metal substrate to act as a current collector in a battery. For example, there is a point where the metal substrate may be etched too much (e.g., extend too far into the major surface of the metal substrate) that the decreased ability of the metal substrate to act as a suitable current collector outweighs the benefit of increasing the etched tunnel depth and promoting the mechanical adhesion between the electrode composition and the metal substrate by etching the metal substrate. Additionally, etching the metal substrate such that a plurality of tunnels extend through the entire thickness of the metal substrate may decrease the integrity of the metal substrate. Thus, aspects of this disclosure are directed to etching a metal substrate of an electrode such that the mechanical adhesion between the electrode composition and the metal substrate is increased, while also maintaining a portion of the metal substrate such that the metal substrate may still function as a suitable current collector and substrate.

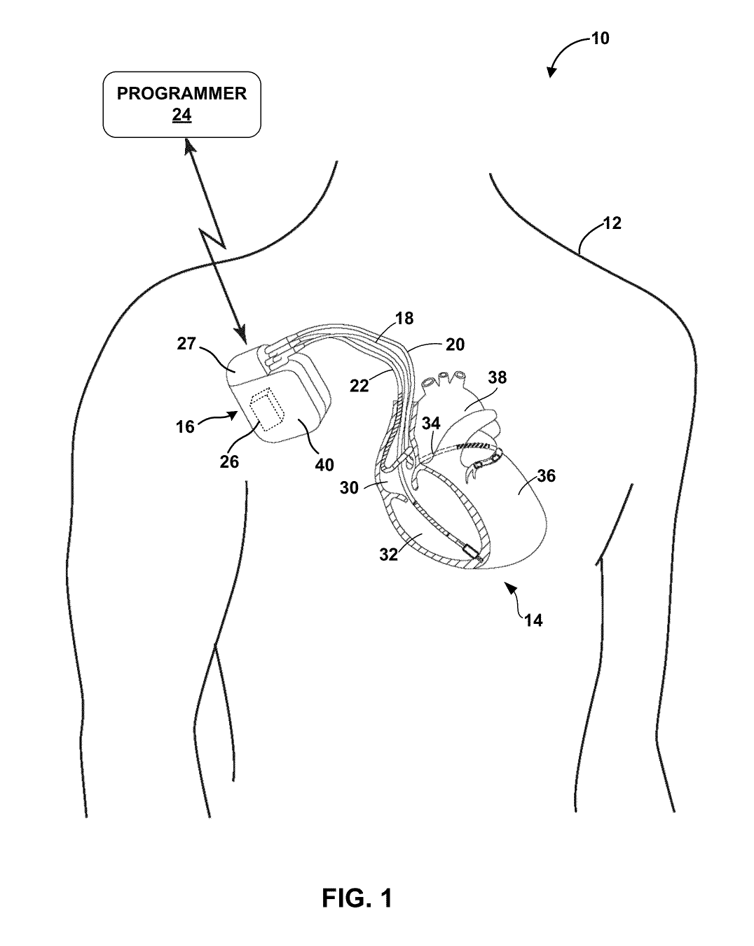

FIG. 1 is a conceptual diagram that illustrates an example therapy system 10 that may be used to provide therapy to a patient 12. Patient 12 ordinarily, but not necessarily, will be a human. Therapy system 10 may include an IMD 16, and a programmer 24. In the example illustrated in FIG. 1, IMD 16 has a battery 26 positioned within a housing 40 of the IMD 16.

While the examples in the disclosure are primarily directed to a battery 26 positioned within housing 40 of an IMD 16, in other examples, battery 26 may be utilized with other implantable medical devices. For example, battery 26 may be utilized with an implantable drug delivery device, an implantable monitoring device that monitors one or more physiological parameter of patient 12, an implantable neurostimulator (e.g., a spinal cord stimulator, a deep brain stimulator, a pelvic floor stimulator, a peripheral nerve stimulator, or the like), a cardiac or neurological lead, or the like. In general, battery 26 may be attached to or implanted proximate to any medical device configured to be implanted in a body of a patient 12.

Moreover, while examples of the disclosure are primarily described with regard to implantable medical devices, examples are not limited as such. Rather, some examples of the batteries described herein may be employed in any medical device including non-implantable medical devices. For example, an example battery may be employed to supply power to a medical device configured delivery therapy to a patent externally or via a transcutaneoulsy implanted lead or drug delivery catheter.

In the example depicted in FIG. 1, IMD 16 is connected (or “coupled”) to leads 18, 20, and 22. IMD 16 may be, for example, a device that provides cardiac rhythm management therapy to heart 14, and may include, for example, an implantable pacemaker, cardioverter, and/or defibrillator that provides therapy to heart 14 of patient 12 via electrodes coupled to one or more of leads 18, 20, and 22. In some examples, IMD 16 may deliver pacing pulses, but not cardioversion or defibrillation shocks, while in other examples, IMD 16 may deliver cardioversion or defibrillation shocks, but not pacing pulses. In addition, in further examples, IMD 16 may deliver pacing pulses, cardioversion shocks, and defibrillation shocks.

IMD 16 may include electronics and other internal components necessary or desirable for executing the functions associated with the device. In one example, IMD 16 includes one or more processors, memory, a signal generator, sensing module and telemetry modules, and a power source. In general, memory of IMD 16 may include computer-readable instructions that, when executed by a processor of the IMD, cause it to perform various functions attributed to the device herein. For example, a processor of IMD 16 may control the signal generator and sensing module according to instructions and/or data stored on memory to deliver therapy to patient 12 and perform other functions related to treating condition(s) of the patient with IMD 16.

The signal generator of IMD 16 may generate electrical stimulation that is delivered to patient 12 via electrode(s) on one or more of leads 18, 20, and 22, in order to provide (e.g., cardiac sensing, pacing signals, or cardioversion/defibrillation shocks). The sensing module of IMD 16 may monitor electrical signals from electrode(s) on leads 18, 20, and 22 of IMD 16 in order to monitor electrical activity of heart 14. In one example, the sensing module may include a switch module to select which of the available electrodes on leads 18, 20, and 22 of IMD 16 are used to sense the heart activity. Additionally, the sensing module of IMD 16 may include multiple detection channels, each of which includes an amplifier, as well as an analog-to-digital converter for digitizing the signal received from a sensing channel (e.g., electrogram signal processing by a processor of the IMD).

A telemetry module of IMD 16 may include any suitable hardware, firmware, software or any combination thereof for communicating with another device, such as programmer 24 (FIG. 1). Under the control of a processor of IMD 16, the telemetry module may receive downlink telemetry from and send uplink telemetry to programmer 24 with the aid of an antenna, which may be internal and/or external.

The various components of IMD 16 may be coupled to a power source such as battery 26, which may include a rechargeable or non-rechargeable battery. A non-rechargeable battery may be capable of holding a charge for several years, while a rechargeable battery may be remotely charged from an external device (e.g., on a weekly, monthly or annual basis). In general, battery 26 may supply power to one or more electrical components of IMD 16, such as, e.g., the signal or pulse generator, to allow IMD 16 to deliver therapy to patient 12, e.g., in the form of monitoring one or more patient parameters, delivery of electrical stimulation or delivery on a therapeutic drug fluid. As will be described further below, battery 26 may include at least one electrode comprising a metal substrate including a plurality of tunnels extending between approximately 5% and approximately 80% into one major surface of the metal substrate. In other examples, battery 26 may include at least one electrode comprising a metal substrate including a plurality of tunnels extending between approximately 5% and approximately 40% into at least one major surface of the metal substrate. The electrode(s) may also include an electrode composition deposited on the major surface of the metal substrate, where a portion of the electrode composition is positioned within the plurality of tunnels.

Leads 18, 20, 22 that are coupled to IMD 16 may extend into the heart 14 of patient 12 to sense electrical activity of heart 14 and/or deliver electrical stimulation to heart 14. In the example shown in FIG. 1, right ventricular (RV) lead 18 extends through one or more veins (not shown), the superior vena cava (not shown), and right atrium 30, and into right ventricle 32. Left ventricular (LV) coronary sinus lead 20 extends through one or more veins, the vena cava, right atrium 30, and into the coronary sinus 34 to a region adjacent to the free wall of left ventricle 36 of heart 14. Right atrial (RA) lead 22 extends through one or more veins and the vena cava, and into the right atrium 30 of heart 14. In other examples, IMD 16 may deliver stimulation therapy to heart 14 by delivering stimulation to an extravascular tissue site in addition to or instead of delivering stimulation via electrodes of intravascular leads 18, 20, 22. In the illustrated example, there are no electrodes located in left atrium 36. However, other examples may include electrodes in left atrium 36.

IMD 16 may sense electrical signals attendant to the depolarization and repolarization of heart 14 (e.g., cardiac signals) via electrodes (not shown in FIG. 1) coupled to at least one of the leads 18, 20, and 22. In some examples, IMD 16 provides pacing pulses to heart 14 based on the cardiac signals sensed within heart 14. The configurations of electrodes used by IMD 16 for sensing and pacing may be unipolar or bipolar. IMD 16 may also deliver defibrillation therapy and/or cardioversion therapy via electrodes located on at least one of the leads 18, 20, and 22. IMD 16 may detect arrhythmia of heart 14, such as fibrillation of ventricles 32 and 36, and deliver defibrillation therapy to heart 14 in the form of electrical shocks. In some examples, IMD 16 may be programmed to deliver a progression of therapies (e.g., shocks with increasing energy levels), until a fibrillation of heart 14 is stopped. IMD 16 may detect fibrillation by employing one or more fibrillation detection techniques known in the art. For example, IMD 16 may identify cardiac parameters of the cardiac signal (e.g., R-waves, and detect fibrillation based on the identified cardiac parameters).

In some examples, programmer 24 may be a handheld computing device or a computer workstation. Programmer 24 may include a user interface that receives input from a user. The user interface may include, for example, a keypad and a display, which may be, for example, a cathode ray tube (CRT) display, a liquid crystal display (LCD) or light emitting diode (LED) display. The keypad may take the form of an alphanumeric keypad or a reduced set of keys associated with particular functions. Programmer 24 can additionally or alternatively include a peripheral pointing device, such as a mouse, via which a user may interact with the user interface. In some embodiments, a display of programmer 24 may include a touch screen display, and a user may interact with programmer 24 via the display.

A user, such as a physician, technician, or other clinician, may interact with programmer 24 to communicate with IMD 16. For example, the user may interact with programmer 24 to retrieve physiological or diagnostic information from IMD 16. A user may also interact with programmer 24 to program IMD 16 (e.g., select values for operational parameters of IMD 16).

Programmer 24 may communicate with IMD 16 via wireless communication using any techniques known in the art. Examples of communication techniques may include, for example, low frequency or radiofrequency (RF) telemetry, but other techniques are also contemplated. In some examples, programmer 24 may include a programming head that may be placed proximate to the patient's body near the IMD 16 implant site in order to improve the quality or security of communication between IMD 16 and programmer 24.

In the example depicted in FIG. 1, IMD 16 is connected (or “coupled”) to leads 18, 20, and 22. In the example, leads 18, 20, and 22 are connected to IMD 16 using the connector block 27. For example, leads 18, 20, and 22 are connected to IMD 16 using the lead connector ports in connector block 27. Once connected, leads 18, 20, and 22 are in electrical contact with the internal circuitry of IMD 16. Battery 26 may be positioned within the housing 40 of IMD 16. Housing 40 may be hermetically sealed and biologically inert. In some examples, housing 40 may be formed from a conductive material. For example, housing 40 may be formed from a material including, but not limited to, titanium, stainless steel, among others.

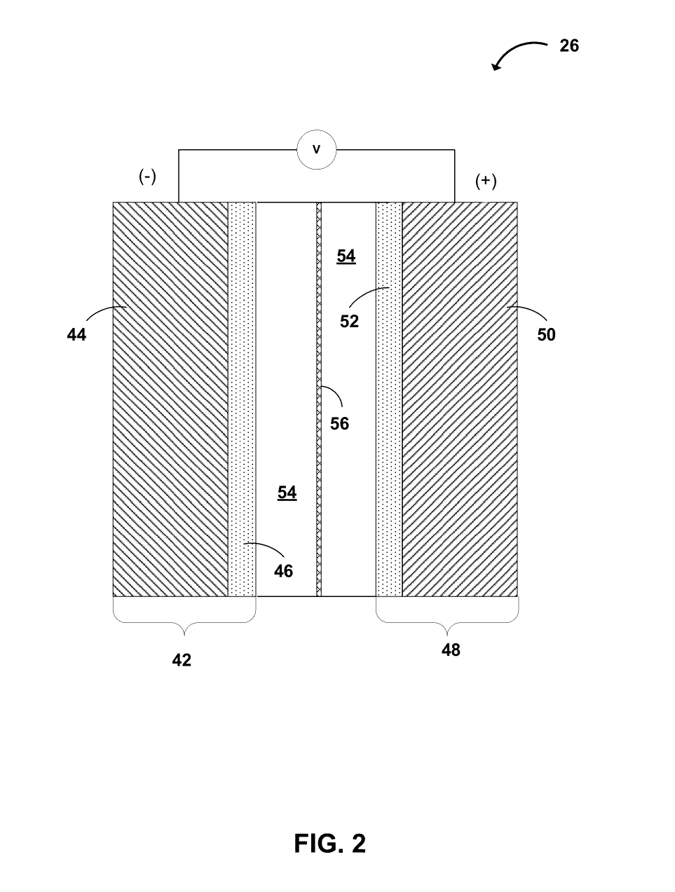

FIG. 2 is a cross-sectional diagram illustrating an example of a battery 26 that may be used in an IMD 16. In one example, battery 26 may be a lithium battery that includes a first electrode 42 and a second electrode 48. Additionally, battery 26 may include an electrolyte 54 and a separator 56. Battery 26 may take the form of other types of batteries other than that of a lithium battery.

First electrode 42 may include a metal substrate 44 (e.g., a current collector) and a first electrode composition 46. Current collectors, as used herein, may be defined as a material included in a battery to conduct electrons to or from the electrodes. In the example illustrated in FIG. 2, first electrode 42 is a negative electrode. In some examples, metal substrate 44 of first electrode 42 is a material that may be used as a current collector, such as a metal. In one example, metal substrate 44 is made from at least one of, but not limited to, aluminum, aluminum alloys, copper, copper alloys, titanium, titanium alloys, nickel, and nickel alloys. In the example illustrated in FIG. 2, metal substrate 44 may be 99.99 percent (%) pure aluminum foil.

In some examples, metal substrate 44 may have a thickness within a range of from approximately 50 micrometers (μm) to approximately 150 μm. In other examples, the thickness of metal substrate 44 is within a range of from approximately 75 μm to approximately 125 μm. In yet another example, the thickness of metal substrate is approximately 100 μm. Other substrate thicknesses are contemplated.

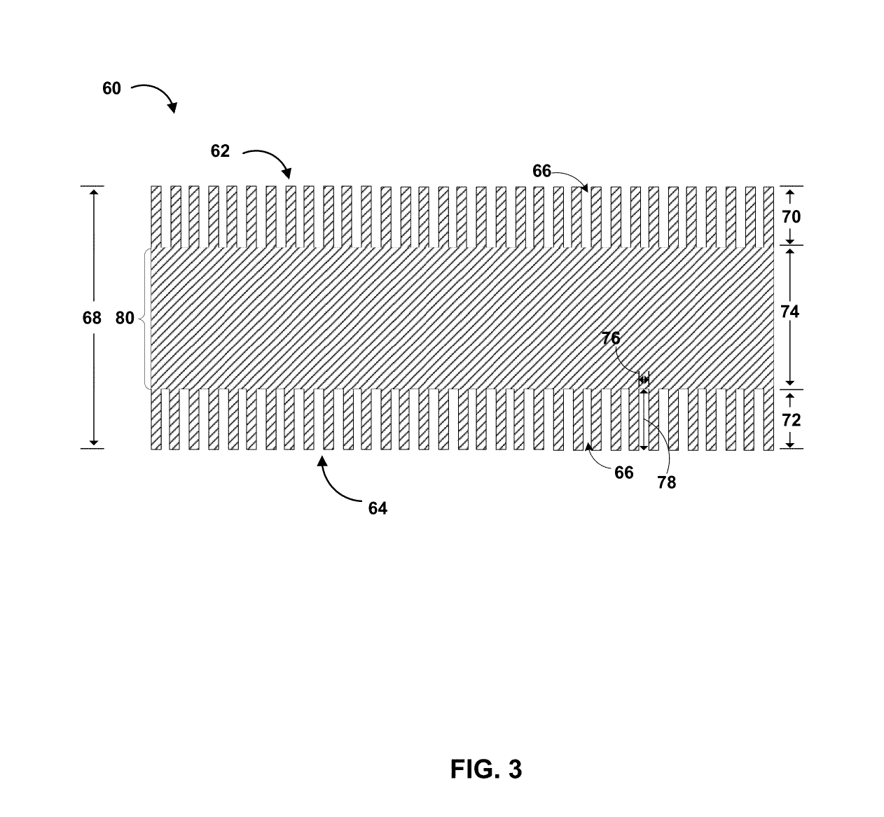

FIG. 3 is a cross-sectional diagram illustrating an example of a metal substrate 60 of an electrode in accordance with aspects of this disclosure. In this example, metal substrate 60 is metal substrate 44 illustrated in FIG. 2. However, unlike that shown in FIG. 2, metal substrate 60 does not include an electrode composition (such as, e.g., first electrode composition 46) deposited on one or more surfaces of metal substrate 60.

Metal substrate 60 may include a first major surface 62 and a second major surface 64 that oppose each other. As illustrated in FIG. 3, metal substrate 60 may define a plurality of tunnels 66 (only two tunnels are labeled in FIG. 3 for ease of illustration) that extend into first major surface 62 and second major surface 64.

In some examples, plurality of tunnels 66 may extend into only one of the major surfaces 62, 64. In an example when the plurality of tunnels extend into only one of the major surfaces 62, 64, the plurality of tunnels may extend into the one major surface within a range of from approximately 5% to approximately 80% of the thickness of the metal substrate. In another example when the plurality of tunnels extend into only one of the major surfaces 62, 64, the plurality of tunnels may extend into the one major surface within a range of from approximately 5% to approximately 40% of the thickness of the metal substrate. In still another example where the plurality of tunnels extend into only one of the major surfaces 62, 64, the plurality of tunnels may extend into the one major surface within a range of from approximately 10% to approximately 20% of the thickness of the metal substrate. In one example, the plurality of tunnels may extend into one major surface approximately 15% of the thickness of the metal substrate.

As illustrated in FIG. 3, plurality of tunnels 66 may extend into both of the major surfaces 62, 64. In an example where plurality of tunnels 66 extend into both major surfaces 62, 64, plurality of tunnels 66 extend into first major surface 62 and second major surface 64 within a range of from approximately 5% to 40% of thickness 68 of metal substrate 60.

In some examples, plurality of tunnels 66 may extend into at the first major surface 62 a distance 70 and the second major surface 63 a distance 72, where distance 70 and distance 72 are approximately 5% to approximately 40% of thickness 68 of metal substrate 60. In other examples, plurality of tunnels 66 may extend into first major surface 62 and second major surface 64 within a range of from approximately 10% to 20% of thickness 68 of metal substrate 60. In one example, plurality of tunnels 66 may extend into first major surface 62 and second major surface 64 approximately 15% of thickness 68 of metal substrate 60. As discussed herein, either one or both of the major surfaces 62, 64 may be etched.

In some examples, distance 70 may be substantially uniform for each tunnel of plurality of tunnels 66 extending into first major surface 62. In other examples, distance 70 may be non-uniform (e.g., variable) amongst each tunnel of the plurality of tunnels 66 extending into first major surface 62. As illustrated in FIG. 3, plurality of tunnels 66 may extend into second major surface 64 a distance 72, where distance 72 may be approximately the same as distance 70. For examples, distance 72 may be within a range of from approximately 5% to 40% of thickness 68 of metal substrate 60. In some examples, distance 70 and distance 72 may be the same. In other examples, distance 70 and distance 72 may be different.

In some examples, plurality of tunnels 66 extend into at least one the major surfaces 62, 64 along substantially a same direction. That is, plurality of tunnels 66 exhibit substantially no fracturing (e.g., tree branching) such that the integrity of the metal substrate 68 may be maintained. For example, plurality of tunnels 66 extend into at least one of major surfaces 62, 64 along a direction that is substantially perpendicular to a plane defined by major surfaces 62, 64.

Plurality of tunnels 66 may have an aspect ratio within a range of from approximately 1:5 to approximately 1:20. The term “aspect ratio”, as used herein, may refer to a ratio of width to length. For example, the aspect ratio of plurality of tunnels 66 may be a ratio of a width 76 of the plurality of tunnels to a length 78 of plurality of tunnels 66. In some examples, plurality of tunnels 66 may have an aspect ratio within a range of from approximately 1:5 to approximately 1:20. In one example, plurality of tunnels 66 may have an aspect ratio of 1:10. Other aspect ratios are contemplated. In some examples, width 76 of plurality of tunnels 66 is within a range of from approximately 1 μm to 3 μm. In one example, the width 76 is 2 μm. In some examples, length 78 of plurality of tunnels 66 is within a range of from approximately 5 μm to 40 μm. In one example, the length 78 is about 15 μm

Metal substrate 60 includes a portion 80 that does include plurality of tunnels 66. That is, portion 80 does not define a plurality of tunnels. As discussed herein, portion 80 that does not include plurality of tunnels 66 maintains the integrity of metal substrate 60 such that the ability of metal substrate 60 to function as a suitable current collector and substrate is not substantially decreased. In some examples, portion 80 has a length 74 that is within a range of from approximately 20% to approximately 95% of thickness 68 of metal substrate 60.

Returning to FIG. 2, first electrode 42 includes a layer of first electrode composition 6 on metal substrate 44. In FIG. 2, first electrode composition 46 may be a negative electrode composition. As illustrated in FIG. 2, the layer of first electrode composition 46 may be deposited on one major surface of metal substrate 44. However, as discussed herein, first electrode composition 46 may be deposited on a first major surface and a second major surface of metal substrate 44.

In some examples, first electrode composition 46 may include at least one active material and at least one additive. As discussed herein, the electrode composition may be deposited onto metal substrate 44 via a solvent. In FIG. 2, where the first electrode composition 46 is a negative electrode composition, the at least one active material may be selected from the group including, but not limited to, silver vanadium oxide, carbon monofluoride, lithium cobalt oxide, lithium nickel oxide, lithium manganese oxide, lithium iron phosphate. In one example, the active material includes at least silver vanadium oxide and carbon monofluoride. While the examples in the disclosure are primarily directed to a lithium battery, in other examples, the first electrode composition may include additional materials. For example, the components of the first electrode composition may vary depending on the type of battery (e.g., lithium, non-lithium, rechargeable, etc.) and the battery application.

In the example of FIG. 2, the at least one additive may include a binder material, conductive additives, and combinations thereof. For example, the binder material include a sodium carboxymethylcellulose (Na-CMC) based binder and/or styrene-butadiene rubber. As discussed herein, depending on the battery type and battery application, the types and amounts of binder material may vary. The binder material may increase the adhesion between the active material and the conductive additives to the metal substrate 44. However, as the amount of binder material increases, various electrical properties of battery 26 may change in a less desirable direction. For example, the energy density may decrease and resistance may increase of battery 26 as the amount of the binder material increases.

In some examples, the conductive additives of the first electrode composition 46 may include a carbonaceous materials. In one non-limiting example, the carbonaceous material is carbon black. As discussed herein, depending on the battery type and battery application, the types and amounts of conductive additives may vary.

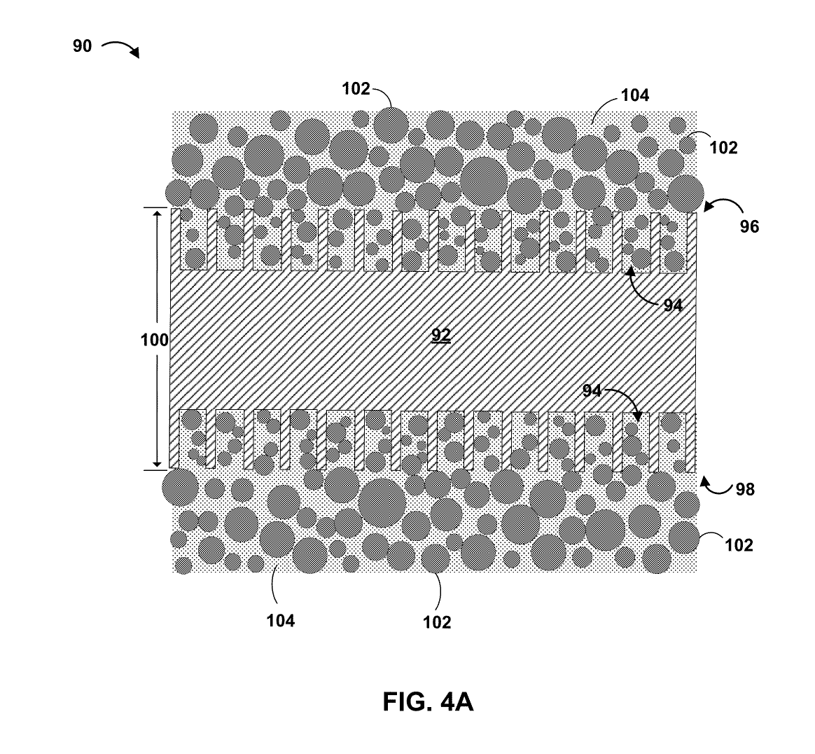

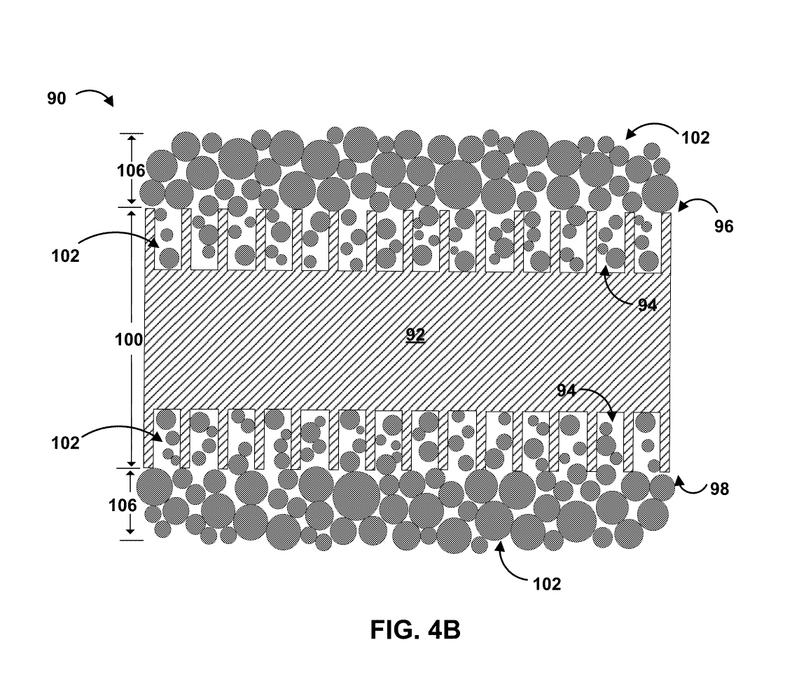

An amount of the electrode composition may be wicked into the plurality of tunnels (e.g., electrode composition 102 positioned in plurality of tunnels 94, as described further below with regard to FIG. 4). For example, the length (e.g., distance 70 and 72) may have a length sufficient to promote wicking while a solvent is present in the slurry. Promoting wicking of the electrode composition by utilizing metal substrate 44 having the plurality of tunnels, may promote mechanical adhesion of first electrode composition 46 to metal substrate 44. Thus, an amount of the binder material in the first electrode composition may be less than compared to an amount of a binder material in an electrode composition deposited on a metal substrate not having the plurality of tunnels.

In some examples, the first electrode composition 46 may be deposited onto the surface of substrate 44 in a solvent-based solution. In one example, the solvent may be selected from, but is not limited to, at least one of water and dimethoxyethane (DME) depending of what type of binder material is used. In some examples, the solvent is used in an amount approximately 50 wt. % of the first electrode composition 46.

Battery 26 in FIG. 1 also includes a second electrode 48. The second electrode 48 may include a metal substrate 50 and a second electrode composition 52. In the example illustrated in FIG. 2, the second electrode 48 is a positive electrode and the second electrode composition 52 is a positive electrode composition.

Metal substrate 50 is a current collector and may be selected from, but is not limited to, aluminum, aluminum alloys, copper, copper alloys, titanium, titanium alloys, nickel, and nickel alloys. Metal substrate 50 may include substantially the same or similar features as described in reference to metal substrate 44. For example, metal substrate 50 may have a thickness of within a range of from approximately 50 μm to approximately 150 μm. In some examples, metal substrate 50 may have a thickness within a range or from approximately 75 μm to approximately 125 μm. In other examples, metal substrate may have a thickness of 100 μm. Additionally, the metal substrate 50 may define a plurality of tunnels as described herein with respect to metal substrate 44 of the first electrode 42.

In the example where battery 26 is a lithium battery, the second electrode composition 52 may include a material or compound that includes lithium. In other examples, the second electrode composition 52 may include other materials, such as other active materials and additives such as conductive additives and binders. As discussed herein, the type of battery and battery application may determine what types of materials are included in the second electrode composition 52.

As seen in FIG. 2, electrolyte 54 may be provided intermediate or between the negative electrode 42 and the positive electrode 48. Electrolyte 54 may provide a medium through which ions (e.g., lithium ions) may travel. In one example, electrolyte 54 may be a liquid (e.g., a lithium salt dissolved n one or more non-aqueous solvents). In another example, the electrolyte 54 may be a lithium salt dissolved in a polymeric material such as poly(ethylene oxide) or silicone. In yet another example, the electrolyte may be an ionic liquid such as N-methyl-N-alkylpyrrolidinium bis(trifluoromethanesulfonyl)imide salts. In a further example, the electrolyte 54 may be a solid state electrolyte such as a lithium-ion conducting glass such as lithium phosphorous oxynitride (LiPON).

Various other electrolytes may be used according to other examples. For example, the electrolyte 54 may be a 1:1 mixture of ethylene carbonate (EC) to diethylene carbonate (DEC) (EC:DEC) in a 1.0 molar (M) salt of lithium hexafluorophosphate (LiPF₆). Electrolyte 54 may include a polypropylene carbonate solvent and a lithium bis-oxalatoborate salt (sometimes referred to as LiBOB). The electrolyte 54 may comprise one or more of a polyvinylidene flouirde (PVDF) copolymer, a PVDF-polyimide material, and organosilicon polymer, a thermal polymerization gel, a radiation cured acrylate, a particulate with polymer gel, an inorganic gel polymer electrolyte, an inorganic gel-polymer electrolyte, a PVDF gel, polyethylene oxide (PEO), a glass ceramic electrolyte, phosphate glasses, lithium conducting glasses, lithium conducting ceramics, and an inorganic ionic liquid or gel, among others.

As also seen in FIG. 2, battery 26 may include a separator 56. Separator 56 may be provided intermediate or between the first electrode 42 and the second electrode 48. In one example, separator 56 is a polymeric material such as a polypropylene/polyethelene or another polyolefin multilayer laminate that includes micropores formed therein to allow electrolyte and lithium ions to flow from one side of the separator 56 to the other. Separator 56 may have a thickness within a range of from approximately 10 μm to 50 μm. In one example, the thickness of the separator is approximately 25 μm. Separator 56 may have an average pore size within the range of from approximately 0.02 μm to 0.10 μm.

A battery case (not shown) may house the battery of FIG. 2 and may be made of stainless steel or another metal. In one example, the battery case may be made of titanium, aluminum, or alloys thereof.

FIG. 4A is a conceptual diagram illustrating an example electrode 90 including an electrode composition 102 being deposited onto metal substrate 92 via solvent 104. As shown in FIG. 4A, metal substrate 92 includes a plurality of tunnels 94 extending into a first major surface 96 and a second major surface 98. The plurality of tunnels 94 extend into each of the first major surface 96 and the second major surface 98 within a range of from approximately 5% to 40% of a thickness 100 of the metal substrate 92.

In some examples, electrode 90 may include an electrode composition 102 deposited onto metal substrate 92. As discussed herein, electrode composition 102 (e.g., including active materials, additives, etc.) may be a powder and have a particle-size distribution. That is, particles of electrode composition 102 may vary in size. As discussed herein, electrode composition 102 may be deposited onto metal substrate 92 via solvent 104.

As illustrated in FIG. 4A, electrode composition 102 may be wicked into plurality of tunnels 94 via solvent 104. That is, the solvent 104 including electrode composition 102 have capillarity such that particles of electrode composition 102 may be wicked into the space defined by plurality of tunnels 94. Since particles of electrode composition 102 have particle-size distribution, smaller size particles may be wicked into the space defined by plurality of tunnels 94. In some examples, electrode composition 102 may be milled to further control the particle size distribution of electrode composition 102. As used herein, milled or milling of particles include the process of grinding, pulverizing, or breaking down particles into smaller particles. In one example, electrode composition 102 may be milled such that 50% of the particles of the electrode composition are less than 20 μm.

In some examples, an amount of electrode composition 102 may be wicked into plurality of tunnels 94 such that a portion of electrode composition 102 is positioned within plurality of tunnels 94. That is, solvent 104 is used to wick electrode composition 102 into plurality of tunnels 94. As seen in FIG. 4A, a portion of electrode composition 102 has been wicked into plurality of tunnels 94 by solvent 104. As illustrated in FIG. 4A, electrode composition 102 and solvent 104 (e.g., an electrode composition slurry) may substantially fill the entire space defined by plurality of tunnels 94. In other examples, the amount of solvent 104 and electrode composition 102 that is wicked into each tunnel of plurality of tunnels 94 may vary.

As discussed herein, wicking electrode composition 102 into plurality of tunnels 94 may promote mechanical adhesion of electrode composition 102 to metal substrate 92. Promoting the mechanical adhesion of electrode composition 102 to metal substrate 92 may enable greater design flexibility for the battery. Additionally, increasing the mechanical adhesion between electrode composition 102 and metal substrate 92 may reduce the amount of binder material in electrode composition 102. As noted above, increasing the amounts of binder material in the electrode composition may undesirably affect electrical properties of the electrode composition.

FIG. 4B is a conceptual diagram illustrating an example electrode 90 including an electrode composition 102 deposited onto metal substrate 92. Electrode 90 in FIG. 4B is electrode 90 in FIG. 4A but does not include solvent 104 (as illustrated in FIG. 4A). As discussed herein, once electrode composition 102 is deposited onto metal substrate 92 via solvent 104 (as illustrated in FIG. 4A), solvent 104 may be removed. As illustrated in FIG. 4B, solvent 104 has been removed. For example, solvent 104 may be removed by drying, leaving electrode composition 102 on major surfaces 96 and 98 of metal substrate 92. At least a portion of electrode composition may be deposited within tunnels 94. Additionally, once solvent 104 is removed, electrode 90 may be compressed to further engage the electrode composition 120 within the plurality of tunnels 94. For example, compressing the electrode 90 may deform further increasing the mechanical adhesion between the electrode composition 102 and metal substrate 92.

In some examples, the portion (e.g., an amount) of electrode composition 102 that is positioned within plurality of tunnels 94 may substantially occupy the space defined by plurality of tunnels 94. In other examples, the portion of electrode composition 102 that is positioned within plurality of tunnels may only partially fill the space defined by plurality of tunnels 94. Additionally, the portion of electrode composition 102 that is positioned within each tunnel of plurality of tunnels 94 may vary. That is, some tunnels 94 may have a greater amount of electrode composition 102 positioned within the tunnels 94 than other tunnels 94. In some examples, some tunnels 95 may not have any electrode composition 102.

As shown in FIG. 4B, plurality of tunnels 94 extend into each major surface 96 and 98 within a range of from approximately 5% to 40% of a thickness 100 of the metal substrate 92. In other examples, plurality of tunnels 94 may extend into major surfaces 96 and 98 within a range of from approximately 10% to 20% of thickness 68 of metal substrate 92. In one example, plurality of tunnels 94 may extend into each major surface 96 and 98 approximately 15% of thickness 68 of metal substrate 60. As discussed herein, in the example where only one major surface is etched, the plurality of tunnels may extend into the major surface within a range of from approximately 5% to approximately 80% of a thickness of the metal substrate.

In some examples, thickness 100 of metal substrate 92 may be within a range of from approximately 50 μm to approximately 150 μm. In some examples, thickness 100 may be within a range of from approximately 75 μm to approximately 125 μm. In other examples, thickness 100 may be approximately 100 μm. In some examples, electrode 90 may have a thickness 106 of electrode composition 102 that is within a range of from approximately 200 μm to approximately 500 μm. In other examples, thickness 106 of electrode composition 102 may be within a range of from approximately 250 μm to approximately 450 μm. In one example, thickness 106 of electrode composition 102 may be 300 μm. Thickness 105 of the electrode composition 102 is a non-limiting example and may vary depending on the type of battery and/or battery application. As discussed herein, electrode 90 may have electrode composition 102 on one or both major surfaces 96 and 98. As illustrated in FIG. 4B, electrode 90 has electrode composition 102 positioned on both major surfaces 96 and 98.

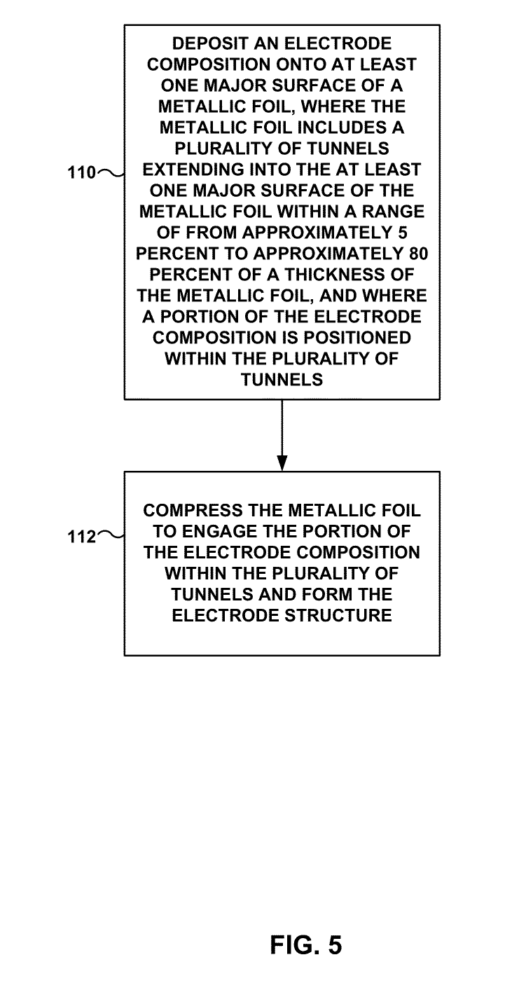

FIG. 5 is a flow diagram illustrating an example method of forming an example electrode structure, such as, e.g., electrode 42, 48, or 90 described herein. The method may include depositing an electrode composition onto at least one major surface of a metallic foil, wherein the metallic foil includes a plurality of tunnels extending into the at least one major surface within a range of from approximately 5 percent to approximately 80 percent of a thickness of the metallic foil, and wherein a portion of the electrode composition is positioned within the plurality of tunnels (110). The metallic foil may be an example of metal substrate 44 or 50 as described herein with respect to FIG. 2. For example, the metallic foil may be 99.99% pure aluminum foil. Additionally, the thickness of the metallic foil may be within a range of from approximately 50 μm to approximately 150 μm.

The plurality of tunnels may be formed by at least one of electrolytic etching and chemical etching. In accordance with examples of this disclosure, etching may be performed by electrolytic etching techniques and chemical etching techniques known to those skilled in the art. In one example, the metallic foil may be etched by employing the etching mechanisms described in U.S. Pat. No. 5,503,718, filed Feb. 22, 1995 and entitled “METHOD OF ETCHING ALUMINUM FOIL FOR ELECTROLYTIC CAPACITORS,” the entire content of which is incorporated herein by this reference. For example, etching the metallic foil may include applying an electrical current between an etch electrode and the metallic foil via a chloride containing solution in an etching tank. While the examples in the disclosure are primarily directed to etching a metal substrate (e.g., a metallic foil), in other examples, the plurality of tunnels may be formed using known techniques to those skilled in the art. As discussed herein, the plurality of tunnels are formed to promote capillary action such that a portion of the electrode composition is wicked into the plurality of tunnels.

The example method of FIG. 5, the method may further include may further include compressing the metallic foil to engage the portion of the electrode composition within the plurality of tunnels and form the electrode structure (112). Compressing the metallic foil may further engage the portion of the electrode composition with the plurality of tunnels. For example, the metallic foil may be compressed using known techniques to those skilled in the art. Examples of compressing the metallic foil include, but are not limited to direct pressing of coupons or calendared between rollers in the form of a passing web among others.

In some examples, the electrode composition may include at least silver vanadium oxide, carbon monofluoride, carbon black, a binder, and a solvent. In some examples, the electrode composition may be deposited using a slurry coating process. For example, a slurry may be formed by mixing the electrode composition with a solvent. The electrode composition may be deposited onto the metal substrate using techniques known to those skilled in the art including, but not limited to, gravure coating, reverse roll coating, knife over roll coating, slot die coating, immersion coating, curtain coating, and air knife coating. As discussed herein, as the electrode composition is deposited onto the major surface of the metallic surface comprising the plurality of tunnels such that a portion of the electrode composition may be wicked into the plurality of tunnels via capillary action.

Once the electrode composition is deposited onto the major surface of the metallic foil, the method may include drying the electrode composition to remove substantially all of the solvent and form an electrode structure. For example, the deposited electrode composition may be heated to remove substantially all of the solvent. The electrode composition may be dried by using known techniques by those skilled in the art. Examples of drying the electrode composition may include, but are not limited to transfer of hot roll, a pass through a drying oven in the form of web as coated, simple placement in a drying oven as individual coupons, microwave energy, among others. The electrode composition may be dried at a temperature within a range of from approximately 50 degrees Celsius (° C.) to approximately 125° C.

### EXAMPLES

### Example 1

### Aluminum Foil

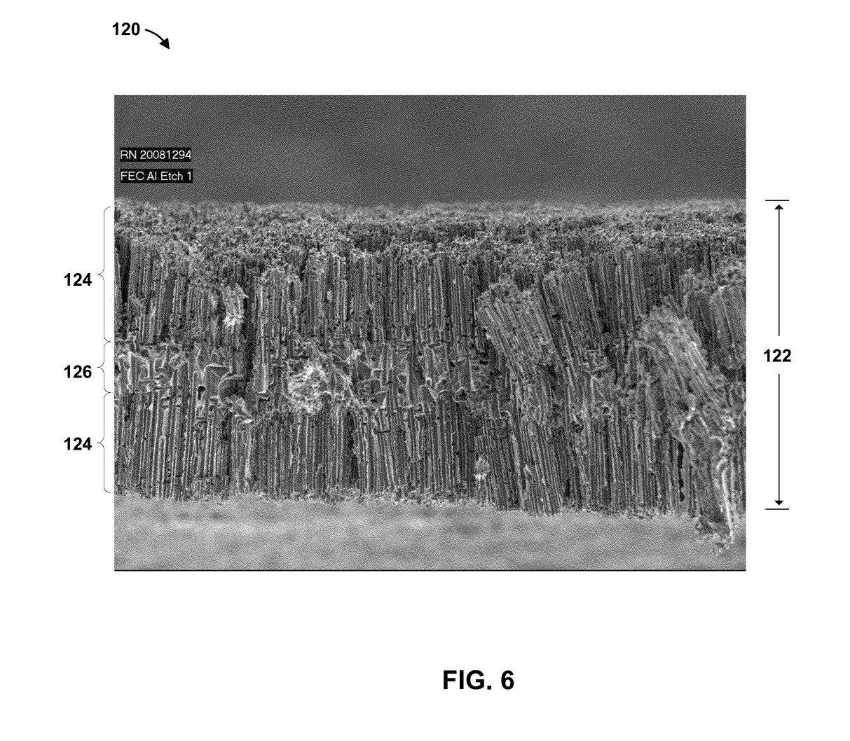

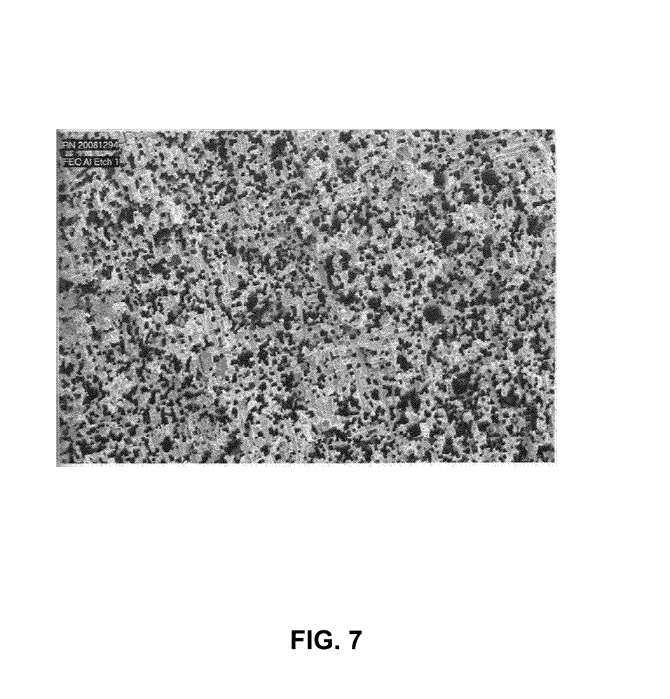

A sample of etched aluminum foil (available from Hitachi, having a purity of about 99.99%, a thickness of about 104 μm) having a plurality of tunnels was used for Example 1. The plurality of tunnels extend into the first major surface and the second major surface of the aluminum foil of Example 1 approximately 40% of the thickness of the aluminum foil. The etched aluminum foil is illustrated in the SEM image of FIG. 6. A planar view of the etched aluminum foil is illustrated in the SEM image of FIG. 7.

FIG. 6 is a SEM image illustrating the sample of etched aluminum foil 120. A broken edge of the etched aluminum foil 120 is illustrated in FIG. 6. As illustrated in FIG. 6, the etched aluminum foil 120 includes a plurality of tunnels 124 extending into a first major surface and a second major surface of the aluminum foil 120. As discussed herein, the plurality of tunnels 124 may extend in the first major surface and the second major surface within a range of from approximately 5% to approximately 40% of a thickness 122 of the aluminum foil 120. As illustrated in FIG. 6, the plurality of tunnels 124 do not extend through the entire thickness 122 of the aluminum foil 120. The etched aluminum foil 120 includes a portion 126 of the etched aluminum foil 120 that does not include the plurality of tunnels.

FIG. 7 is a SEM image illustrating a surface view of the etched aluminum foil illustrated in FIG. 6. As illustrated in FIG. 7, the plurality of tunnels extend into a major surface of the aluminum foil.

### Depositing an Electrode Composition

An electrode composition slurry (e.g., electrode composition in a solvent) was deposited onto the etched aluminum foil. To form the electrode composition slurry, silver vanadium oxide (active material, 5.32 g, available from Lorad Chemical Corporation), carbon monoflouride (active material, 3.73 g, available from Daikin Industries, Ltd.), styrene-butadiene rubber (binder, 0.625 g of a 2.5% solids solution, available from Zeon Corporation), and sodium carboxymethylcellulose (binder, 10.00 g of a 1.00% solids solution, available from Zeon Corporation) were mixed with water (solvent, 50 wt. % of the electrode composition (e.g., ˜9.84 g). This electrode composition slurry was then deposited onto the etched aluminum foil illustrated in the SEM image of FIG. 5 by Knife over plate.

### Drying the Electrode Composition

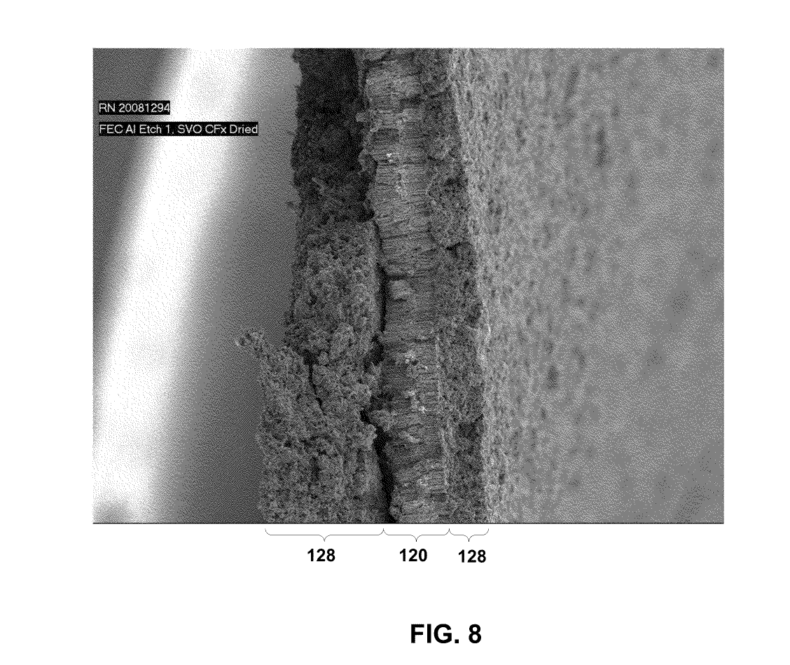

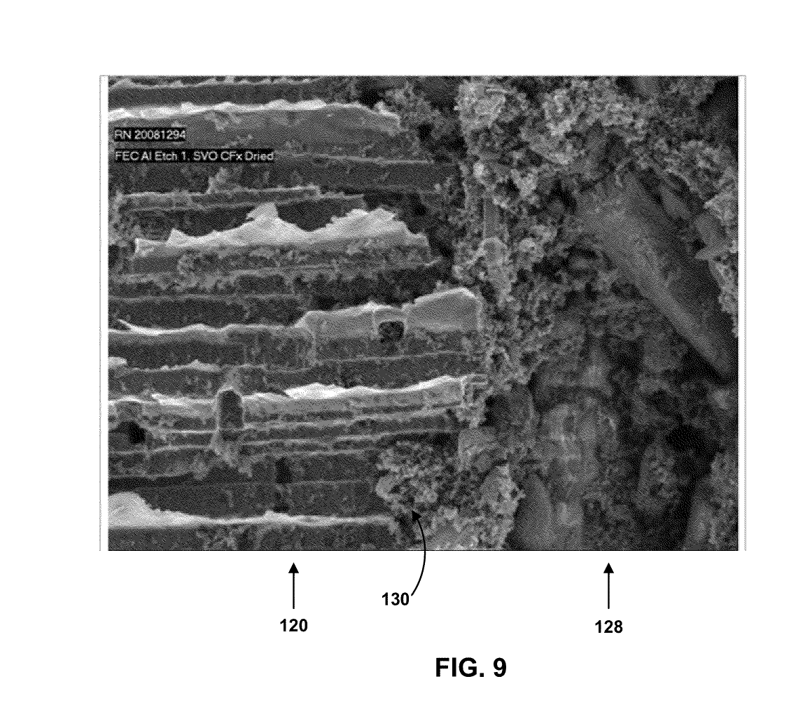

After the electrode composition slurry was deposited onto the etched aluminum foil, the electrode composition slurry was heated to 65° C. to remove substantially all of the solvent from the electrode composition slurry and form an electrode structure including an electrode composition layer. The electrode composition was dried by means of a convection oven. The etched aluminum foil including the dried electrode composition is illustrated in the SEM image of FIG. 8. FIG. 9 is a SEM image illustrating a portion of the electrode composition positioned within a tunnel of the plurality of tunnels etched into the aluminum foil.

As illustrated in FIG. 8, the etched aluminum foil 120 has an electrode composition 128 deposited on a first major surface and a second major surface of the etched aluminum foil 122. As illustrated in FIG. 9, a portion 130 of the electrode composition 128 is positioned within a tunnel of the plurality of tunnels of the etched aluminum foil 120.

### Compressing the Electrode Structure

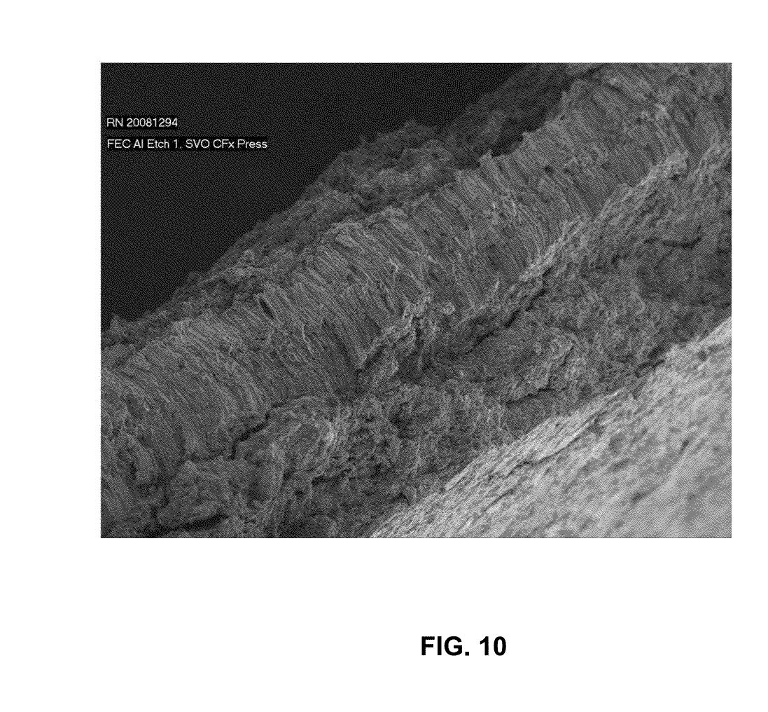

Once substantially all of the solvent is removed, the electrode structure including the electrode composition deposited onto the etched aluminum foil was compressed. The aluminum foil including the dried electrode composition was placed in a hydraulic press and compressed at 243 KPa to further engage the portion of the electrode composition positioned within the plurality of tunnels and form the electrode structure and promote active material density. As the tunnels deform during compression, the mechanical adhesion between the electrode composition and the metal substrate may increase. The electrode structure is illustrated in the SEM Image of FIG. 10.

As illustrated in FIG. 10, the electrode structure including the dried electrode composition deposited onto the etched aluminum foil is compressed. Compressing the electrode structure may further engage the portion of the electrode structure that is positioned within the plurality of tunnels.

Various examples have been described in the disclosure. These and other examples are within the scope of the following claims.

1. A battery comprising:
a first electrode comprising:
a metal substrate including a major surface, wherein a plurality of tunnels extend into the major surface within a range of from approximately 5 percent to approximately 80 percent of a thickness of the metal substrate, and
an electrode composition deposited onto the major surface of the metal substrate, wherein a portion of the electrode composition is positioned within the plurality of tunnels;
a second electrode; and
a separator positioned between the first electrode and the second electrode.

2. The battery of claim 1, wherein each tunnel of the plurality of tunnels extend into the major surface along substantially a same direction.

3. The battery of claim 1, wherein the plurality of tunnels extend into the major surface along a direction substantially perpendicular to the major surface.

4. The battery of claim 1, wherein the plurality of tunnels extend into the major surface within a range of from approximately 5 percent to approximately 40 percent of the thickness of the metal substrate.

5. The battery of claim 1, wherein the plurality of tunnels have an aspect ratio within a range of from approximately 1:5 to approximately 1:20.

6. The battery of claim 1, wherein a portion of the metal substrate does not include the plurality of tunnels.

7. The battery of claim 6, wherein the portion of the metal substrate is within a range of from approximately 20 percent to approximately 95 percent of the thickness of the metal substrate.

8. The battery of claim 1, wherein the metal substrate is aluminum.

9. The battery of claim 1, wherein the thickness of the metal substrate is within a range of from approximately 50 micrometers to approximately 150 micrometers.

10. The battery of claim 1, wherein the electrode composition comprises at least one active material and at least one additive.

11. The battery of claim 10, wherein the at least one active material comprises silver vanadium oxide and carbon monofluoride.

12. The battery of claim 1, further comprising an electrolyte.

13. The battery of claim 1, wherein the major surface comprises a first major surface and the plurality of tunnels comprises a first plurality of tunnels extending into the first major surface within a range of from approximately 5 percent to approximately 40 percent of a thickness of the metal substrate, wherein the metal substrate includes a second major surface opposing the first major surface, wherein a second plurality of tunnels extend into the second major surface within a range of from approximately 5 percent to approximately 40 percent of the thickness of the metal substrate, wherein the electrode composition is deposited onto the second major surface of the metal substrate, and wherein a portion of the electrode composition is positioned within the second plurality of tunnels.

14. The battery of claim 1, wherein the second electrode includes:
a second metal substrate including a first major surface and a second major surface, wherein the first major surface and the second major surface oppose each other, wherein a plurality of tunnels extend into at least one of the first major surface and the second major surface within a range of from approximately 5 percent to approximately 40 percent of a thickness of the second metal substrate; and
a second electrode composition deposited onto the major surface of the metal substrate, wherein a portion of the second electrode composition is positioned within the plurality of tunnels.

15. An implantable medical device comprising:
a housing; and
a battery within the housing, the battery comprising:
a first electrode, comprising:
a metal substrate including a major surface, wherein a plurality of tunnels extend into the major surface within a range of from 5 percent to 80 percent of a thickness of the metal substrate; and
an electrode composition deposited onto the major surface the of the metal substrate, wherein a portion of the electrode composition is positioned within the plurality of tunnels; and
a second electrode.

16. The implantable medical device of claim 15, wherein each tunnel of the plurality of tunnels extend into the major surface along substantially a same direction.

17. The implantable medical device of claim 15, wherein the plurality of tunnels extend into the major surface along a direction substantially perpendicular to the major surface.

18. The implantable medical device of claim 15, wherein the plurality of tunnels extend into the major surface within a range of from approximately 5 percent to approximately 40 percent of the thickness of the metal substrate.

19. The implantable medical device of claim 15, wherein the plurality of tunnels have an aspect ratio within a range of from approximately 1:5 to approximately 1:20.

20. The implantable medical device of claim 15, wherein a portion of the metal substrate does not include the plurality of tunnels.

21. The implantable medical device of claim 15, wherein the portion of the metal substrate is within a range of from 20 percent to 95 percent of the thickness of the metal substrate.

22. The implantable medical device of claim 15, wherein the metal substrate is aluminum.

23. The implantable medical device of claim 15, wherein the thickness of the metal substrate is within a range of from approximately 50 micrometers to approximately 150 micrometers.

24. The implantable medical device of claim 15, wherein the electrode composition comprises at least one active material, and at least one additive.

25. The implantable medical device of claim 24, wherein the at least one active material comprises at least silver vanadium oxide and carbon monofluoride.

26. The implantable medical device of claim 15, wherein in the battery further comprises an electrolyte.

27. The implantable medical device of claim 15, wherein the major surface comprises a first major surface and the plurality of tunnels comprises a first plurality of tunnels extending into the first major surface within a range of from approximately 5 percent to approximately 40 percent of a thickness of the metal substrate, wherein the metal substrate includes a second major surface opposing the first major surface, wherein a second plurality of tunnels extend into the second major surface within a range of from approximately 5 percent to approximately 40 percent of the thickness of the metal substrate, wherein the electrode composition is deposited onto the second major surface of the metal substrate, and wherein a portion of the electrode composition is positioned within the second plurality of tunnels.

28. The implantable medical device of claim 15, wherein the second electrode includes:
a second metal substrate including a first major surface and a second major surface, wherein the first major surface and the second major surface oppose each other, wherein a plurality of tunnels extend into at least one of the first major surface and the second major surface within a range of from approximately 5 percent to approximately 40 percent of a thickness of the second metal substrate; and
a second electrode composition deposited onto the major surface of the metal substrate, wherein a portion of the second electrode composition is positioned within the plurality of tunnels.

29. A method of forming an electrode structure comprising:
depositing an electrode composition onto at least one major surface of a metallic foil, wherein the metallic foil includes a plurality of tunnels extending into the at least one major surface within a range of from approximately 5 percent to approximately 80 percent of a thickness of the metallic foil, and wherein a portion of the electrode composition is positioned within the plurality of tunnels; and
compressing the metallic foil to engage the portion of the electrode composition within the plurality of tunnels and form the electrode structure.

30. The method of claim 29, wherein the electrode composition includes at least silver vanadium oxide, carbon monofluoride, carbon black, a binder, and a solvent.

31. The method of claim 30, further comprising:
drying the electrode composition to remove substantially all of the solvent.

32. The method of claim 29, wherein the metallic foil further comprises an aluminum foil, wherein the aluminum foil has a thickness within a range of approximately 50 micrometers to approximately 150 micrometers.
